(19) United States
(12) Patent Application Publication
(10) Pub. No.: US 2026/0219636 A1
(43) Pub. Date: Jul. 30, 2026

(54) REGULATING SYSTEM FOR A TIMEPIECE MOVEMENT

(71) Applicant: CSEM, Neuchâtel (CH)

(72) Inventor: Grégory Musy, Le Mont-sur-Lausanne (CH)

(73) Assignee: CSEM, Neuchâtel (CH)

(21) Appl. No.: 19/144,742

(22) PCT Filed: Dec. 28, 2023
(86) PCT No.: PCT/EP2023/087923

§ 371 Date: Jul. 15, 2025

(30) Foreign Application Priority Data
Dec. 28, 2022 (EP) 22216895.7
Nov. 30, 2023 (EP) 23213488.2

(51) Int. Cl. G04B 17/32; G04B 17/04; G04B 17/06

(52) U.S. Cl. CPC G04B 17/32; G04B 17/045; G04B 17/06

(57) ABSTRACT

The regulating system (150; 150′) for a timepiece movement (300) includes: an inertial element (4; 4′), a frame (6), and an elastic return system (1; 1′; 2,3) for connecting the inertial element (4; 4′) to the frame (6) such that the inertial element and the elastic return system (1; 1′,2,3) form an oscillator (100; 100′), the elastic return system (1; 1′,2,3) including: first, second and third elastic return elements (1; 1′,2,3) having first, second, and third stiffnesses k1, k2, k3, respectively, and a device (200) for modifying the third stiffness k3, the first elastic return element (1; 1′) and the second elastic return element (2) being mounted in series between the inertial element and the frame (6), and the third elastic return element (3) and the second elastic return element (2) being mounted in parallel between the frame (6) and the first elastic return element (1; 1′).

The invention relates to a regulating system for a timepiece movement. The invention also relates to a device for modifying the stiffness of an elastic return element. The invention further relates to a timepiece movement comprising such a regulating system or such a device for modifying stiffness. The invention finally relates to a timepiece comprising such a timepiece movement or such a regulating system or such a device for modifying stiffness.

Mechanical timepiece movements are commonly provided with an oscillator in the form of an assembly constituted by an inertial element and an elastic return element, in particular a balance and a hairspring.

In order for such an assembly to constitute a time base that is sufficiently accurate to ensure the correct operation of the movement, means for adjusting the inertial element or the elastic return element are used. These may, for example, be adjustment means for varying the inertia of the inertial element, or means for acting on the stiffness of the elastic return element. In particular, the inertial element may be provided with inertia blocks or adjusting screws that can be moved to allow more or less fine adjustment of the rate of the movement, of the order of a few seconds or tens of seconds per day. These inertia blocks may, for example, be adjusted by a watchmaker when the inertial element is stationary and, more particularly, when the movement is stationary. Additionally, or alternatively, the stiffness of the elastic return element may be adjusted by modifying the effective length of said element, for example by means of an index. Although such a system has the advantage of being adjustable while the inertial element is in motion, it does not allow sufficiently accurate adjustment, with accuracy comparable to that provided by moving the inertia blocks or adjusting screws of the inertial element.

Patent application EP 4 006 648 relates to a device for adjusting the effective length of a first elastic return element linked to an inertial element, which has the particularity of being directly integrated into the first elastic return element. In particular, this document discloses a first elastic return element in the form of a hairspring whose outer end comprises a set of elastic elements. These are designed to move a clamp in a precise manner opposite the terminal part of the outer end of the hairspring. The effective length of the hairspring can thus be adjusted, modifying the stiffness of the hairspring and therefore the frequency of the oscillator, i.e., of the inertial element/hairspring assembly, by modifying the ratio k/I in which k is the stiffness of the hairspring and I the inertia of the balance. However, such a device is particularly sensitive to variations in the effective length of the hairspring. Indeed, for an oscillator with a nominal frequency of 4 Hz, for example, a modification in the stiffness of the hairspring of approximately 10% results in a rate variation of several thousand seconds per day. With such an adjustment device, it is therefore very difficult to achieve fine adjustment of the order of a few seconds or tens of seconds per day. For a given hairspring, the adjustment in length that would be needed in order to adjust the rate by approximately ten seconds per day can be estimated at a few dozen micrometers. Moreover, there is a risk that acting directly on the length of the hairspring may disrupt the operation of the oscillator.

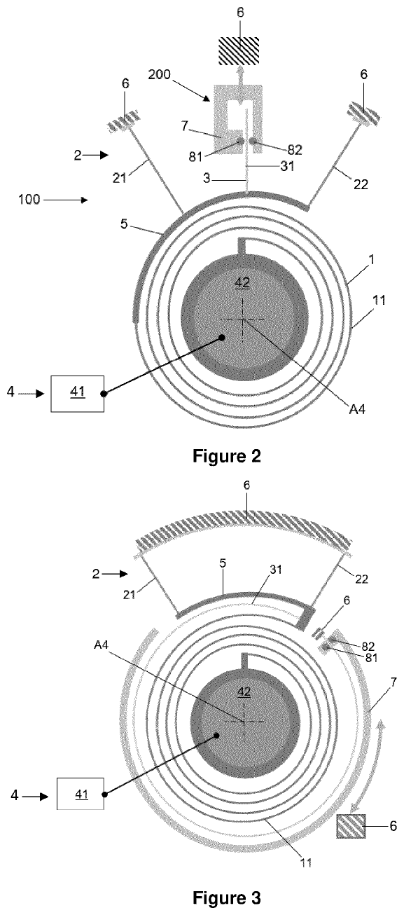

Patent FR 833 085 relates to a method for synchronizing an oscillator of a mechanical clock with an electrical reference oscillator. According to one particular embodiment shown in FIG. 2 of the patent specification, the oscillator of the clock comprises a balance returned by two hairsprings, which preferably have the same dimensions, the respective inner ends of which are secured to the balance staff and the respective outer ends are secured to a frame, the active length of one of the two hairsprings being capable of being modified by means of an additional device controlled by the electrical reference oscillator. Such an arrangement, with two hairsprings arranged in parallel, helps double the precision with which the rate of the mechanical clock can be adjusted, because the stiffness of a single one of the two springs can be modified. However, this gain is not sufficient to achieve fine adjustment of the order of a few seconds or tens of seconds per day, in particular by means of an index.

Patent application EP 4 009 115 discloses an oscillator that has the particularity of comprising a first elastic return element in the form of a hairspring linked to an inertial element in the form of a balance, and a second elastic return element linked in series with the hairspring, the stiffness of this second elastic return element being capable of being modified by prestressing means designed to apply a variable force or torque to the second elastic return element without modifying the stiffness of the hairspring. The stiffness of the second elastic return element is preferably greater than that of the hairspring, meaning that modifying the stiffness of the second elastic return element allows finer adjustment of the rate than if the stiffness of the hairspring were to be acted on directly. However, it appears that the stiffness of the second elastic return element must be very much greater than that of the hairspring, of the order of one thousand or around ten thousand times greater than that of the hairspring to allow for rate variations of the order of a few seconds per day by modifying said stiffness of the second elastic return element. Moreover, this modification in the stiffness of the second elastic return element needs to be possible without varying the position of the outer end of the hairspring, which is very difficult to achieve in practice.

Patent application EP 4 016 194 discloses a concept similar to that which forms the subject matter of application EP 4 009 115, but for a one-piece oscillator. In particular, this oscillator comprises a flexible guide formed from elastic blades, which is designed to define a virtual pivot for an inertial element, and means for adjusting the stiffness of the oscillator comprising a flexible element arranged in series with the flexible guide. These adjustment means also comprise prestressing means designed to apply a variable force or torque to the flexible element in order to vary its stiffness. Once again it appears that the flexible element has to have a stiffness very much greater than that of the flexible guide to allow variations in rate of the order of a few seconds per day by modifying said stiffness of the flexible element, without varying the positioning of the virtual pivot defined by the flexible guide, which is very difficult to achieve in practice.

The aim of the invention is to provide a regulating system that helps overcome the abovementioned problems and improve the regulating systems known from the prior art. In particular, the invention proposes a regulating system that allows fine and reliable adjustment of the oscillation frequency of an oscillator. By virtue of such a system, the adjustment may be made while the oscillator is in operation, and without affecting it.

According to a first aspect of the invention, subject matter is defined by the following propositions:
1. Regulating system (150; 150′) for a timepiece movement (300) comprising:
   an inertial element (4; 4′),
   a frame (6), and
   an elastic return system (1; 1′, 2, 3) intended to link the inertial element (4; 4′) to the frame (6) so that the inertial element (4; 4′) and the elastic return system (1; 1′, 2, 3) form an oscillator (100; 100′), the elastic return system (1; 1′, 2, 3) comprising:
   a first elastic return element (1; 1′) having a first stiffness k1,
   a second elastic return element (2) having a second stiffness k2,
   a third elastic return element (3) having a third stiffness k3, and
   a device (200) for modifying the third stiffness k3, the first elastic return element (1; 1′) and the second elastic return element (2) being assembled in series between the inertial element (4; 4′) and the frame (6), and
   the third elastic return element (3) and the second elastic return element (2) being assembled in parallel between the frame (6) and the first elastic return element (1; 1′).
2. Regulating system (150; 150′) according to proposition 1, wherein:
   k2+k3>k1, or even k2+k3>>k1, in particular k2+k3>10×k1, and/or
   the second stiffness k2 is substantially greater than the first stiffness k1, in particular the second stiffness k2 is substantially greater than the first stiffness k1 and substantially greater than the third stiffness k3.
3. Regulating System (150; 150′) According to Proposition 1 or 2, wherein:
   the first stiffness k1 and the third stiffness k3 are similar or of the same order, in particular k3=α×k1 in which 0.5≤α≤2, and
   the second stiffness k2 is substantially greater than the first stiffness k1 and the third stiffness k3, in particular k2=β×k1 and/or k2=β×k3 in which 10≤β≤80, preferably β=20 or β~20.
4. Regulating system (150; 150′) according to proposition 1 or 2,wherein:
   the second stiffness k2 and the third stiffness k3 are similar or of the same order, in particular k3=γ×k2 in which 0.5≤γ≤2, and
   the second stiffness k2 and the third stiffness k3 are substantially greater than the first stiffness k1, in particular k2=δ×k1 and/or k3=δ×k1 in which 100≤δ≤200, preferably δ=125 or δ~125.
5. Regulating system (150; 150′) according to one of propositions 1 to 4, wherein the inertial element (4; 4′) and the elastic return system (1; 1′, 2, 3) are configured and/or arranged so that the oscillation frequency of the oscillator (100; 100′) is between 8 Hz and 100 Hz, or even is equal to or greater than 100 Hz.
6. Regulating system (150) according to one of propositions 1 to 5, wherein the first elastic return element (1) is a hairspring (1) comprising at least one blade (11) linked to the inertial element (4), the inertial element (4) being pivoted in relation to the frame (6) about a geometric axis (A4).
7. Regulating system (150′) according to one of propositions 1 to 5, wherein the first elastic return element (1′) is a flexible guide (1′)

comprising, in particular, two blades (11′, 12′), configured and/or arranged to elastically return and guide, and in particular to pivot, about a geometric axis (A4′), the inertial element (4′).
8. Regulating system (150; 150′) according to one of propositions 1 to 7, wherein the second elastic return element (2) comprises flexible blades (21, 22) embedded in the frame (6) and defining an RCC pivot for the first elastic return element (1 1′), in which the virtual center of intersection of the flexible blades (21, 22) coincides with a point through which a geometric axis (A4; A4′) passes about which the inertial element (4; 4′) is pivoted.
9. Regulating system (150; 150′) according to one of propositions 1 to 8, wherein the third elastic return element (3) comprises a straight or curved elastic blade (31).
10. Regulating system (150; 150′) according to one of propositions 1 to 9, wherein the first, second and third elastic return elements are linked to each other by a connecting member (5), in particular a connecting member (5) that is part of the first elastic return element (1; 1′) or formed in the continuation of a blade (11) of a hairspring (1) forming the first elastic return element (1) or formed in the continuation of blades (11′, 12′) of a flexible guide (1′) forming the first elastic return element (1′).
11. Regulating system (150) according to one of propositions 1 to 10, wherein the second elastic return element (2) is a curved blade (21) formed in the continuation of a blade (11) of a hairspring (1) forming the first elastic return element (1).
12. Regulating system (150; 150′) according to one of propositions 1 to 11, wherein the inertial element (4; 4′) and the first, second and third elastic return elements are made in a single piece or form a one-piece component.
13. Regulating system (150; 150′) according to one of propositions 1 to 12, wherein at least one of the first, second and third elastic return elements may comprise, at least partially:
   monocrystalline silicon of any orientation, and/or
   polycrystalline silicon, and/or
   amorphous silicon, and/or
   amorphous silicon dioxide, and/or
   doped silicon of any type and level of doping, and/or
   porous silicon, and/or
   silicon carbide, and/or
   glass, and/or
   a composite material, and/or
   technical ceramic, and/or
   quartz.
14. Adjustment device (200) for a regulating system (150; 150′) according to one of propositions 1 to 13, the device (200) being a device for modifying a third stiffness k3 of a third elastic return element (3), in particular a device for modifying an active length of the third elastic return element (3), in particular a device for modifying an active length of at least one blade (31) of the third elastic return element (3).
15. Adjustment device (200) according to proposition 14, wherein it comprises a one-piece structure (900) intended to be mounted on a frame (6) of a timepiece movement (300) of a timepiece (400).
16. Adjustment device (200) according to proposition 15, wherein it comprises a connecting member (5) intended to support a first elastic return element (1) of a regulating system according to one of propositions 1 to 13 and forming part of the one-piece structure (900).
17. Adjustment device (200) according to proposition 15 or 16, wherein it comprises:
   the first elastic return element (1), and
   the second elastic return element (2), and
   the third elastic return element (3), of a regulating system according to one of propositions 1 to 13, this first elastic return element (1), this second elastic return element (2) and this third elastic return element (3) forming part of the one-piece structure (900).
18. Adjustment device (200) according to one of propositions 14 to 17, wherein it comprises a pair of clamps (81, 82), in particular a pair of clamps (81, 82) forming part of the one-piece structure (900), the pair of clamps being:
   able to be moved relative to a frame (6), and/or
   intended to clamp a blade (31), in particular a blade (31) of the third elastic return element of a regulating system according to one of propositions 1 to 13, and/or
   able to move relative to said blade.
19. Timepiece movement (300) comprising a regulating system (150; 150′) according to one of propositions 1 to 13 and/or a device (200) according to one of propositions 14 to 18.
20. Timepiece (400), in particular a wristwatch (400), comprising a regulating system (150; 150′) according to one of propositions 1 to 13 and/or a device (200) according to one of propositions 14 to 18 and/or a timepiece movement (300) according to proposition 19.
21. Method for adjusting an oscillator (100; 100′) of a regulating system (150; 150′) according to one of propositions 1 to 13 or a timepiece movement (300) according to proposition 19 or a timepiece (400) according to proposition 20, the method comprising a step of

modifying the third stiffness k3 of the third elastic return element (3), in particular of modifying an active length of the third elastic return element (3), in particular of modifying an active length of at least one blade (31) of the third elastic return element (3).

According to a second aspect of the invention, subject matter is defined by the following propositions:
22. Regulating system (150) for a timepiece movement (300) comprising:
   a frame (6),
   an assembled balance (4) pivoted in relation to the frame (6) about a geometric axis (A4),
   an elastic return system (1, 2, 3) intended to link the assembled balance (4) to the frame (6) so that the assembled balance (4) and the elastic return system (1, 2, 3) form an oscillator (100), the elastic return system (1, 2, 3) comprising:
   a first elastic return element in the form of a first hairspring (1) having a first stiffness k1,
   a second elastic return element (2) having a second stiffness k2, and
   a third elastic return element (3) having a third stiffness k3, the first elastic return element (1) and the second elastic return element (2) being assembled in series between the assembled balance (4) and the frame (6), and the third elastic return element (3) and the second elastic return element (2) being assembled in parallel between the frame (6) and the first elastic return element (1).
23. Regulating system (150) according to proposition 22, wherein it comprises a device (200) for modifying the third stiffness k3.
24. Regulating system (150) according to proposition 22 or 23, wherein:
   k2+k3>k1, or even k2+k3>>k1, especially k2+k3>10×k1, in particular k2+k3>100×k1, in which k2=k3 or 0.5<k2/k3<2, and/or
   k2+k3>k1, or even k2+k3>>k1, especially k2+k3>10×k1, in particular k2+k3>100×k1, and/or
   the second stiffness k2 is substantially greater than the first stiffness k1, in particular the second stiffness k2 is substantially greater than the first stiffness k1 and substantially greater than the third stiffness k3.
25. Regulating system (150) according to one of propositions 22 to 24, wherein:
   the first stiffness k1 and the third stiffness k3 are similar or of the same order, in particular k3=α×k1 in which 0.5≤α≤2, and
   the second stiffness k2 is substantially greater than the first stiffness k1 and the third stiffness k3, in particular k2=β×k1 and/or k2=β×k3 in which 10≤β≤80, preferably β=20 or β~20.
26. Regulating System (150) According to One of Propositions 22 to 25, wherein:
   the second stiffness k2 and the third stiffness k3 are similar or of the same order, in particular k3=γ×k2 in which 0.5≤γ≤2, and
   the second stiffness k2 and the third stiffness k3 are substantially greater than the first stiffness k1, in particular k2=δ×k1 and/or k3=δ×k1 in which 100≤δ≤200, preferably δ=125 or δ~125.
27. Regulating system (150) according to one of propositions 22 to 26, wherein the assembled balance (4) and the elastic return system (1, 2, 3) are configured and/or arranged so that the oscillation frequency of the oscillator (100) is between 3 Hz and 8 Hz, in particular 4 Hz or 5 Hz.
28. Regulating system (150) according to one of propositions 22 to 27, wherein the first hairspring (1) comprises at least one first blade (11) linked to the assembled balance (4), in particular via a collet (14) arranged at a first proximal end of the first blade (11) and fastened to a staff (42) secured to the balance (41).
29. Regulating system (150) according to proposition 28, wherein the first hairspring (1) comprises a first connecting member (12) arranged at a first distal end of the first blade (11) and linking the first hairspring (1) to the second elastic return element (2), in particular by means of a connecting member (5).
30. Regulating system (150) according to one of propositions 28 to 29,

wherein the collet (14), the first blade (11) and the first connecting member (12) form a one-piece component.
31. Regulating system (150) according to one of propositions 22 to 30, wherein the third elastic return element (3) comprises a second hairspring (3) including at least one second blade (31), the second proximal end (34) of which is intended to fasten said second hairspring (3) to the frame (6).
32. Regulating system (150) according to proposition 31, wherein the second hairspring (3) also comprises a second connecting member (32) arranged at a second distal end of the second blade (31), linking said hairspring (3) to the second elastic return element (2), in particular by means of a connecting member (5).
33. Regulating system (150) according to one of propositions 31 to 32, wherein the second proximal end (34), the second blade (31) and the second connecting member (32) form a one-piece component.
34. Regulating system (150) according to one of propositions 22 to 33, wherein the second elastic return element (2) comprises at least one pair, and in particular two pairs, of elastic blades (21a, 21b, 22a, 22b) forming a flexible guide, in particular an RCC pivot, for the first

hairspring (1) and the second hairspring (3), in which the virtual center of intersection of the blades coincides with a point through which the axis (A4) passes.
35. Regulating system (150) according to proposition 34, wherein the elastic blades (21a, 21b, 22a, 22b) are each U-shaped or substantially U-shaped or V-shaped or substantially V-shaped or W-shaped or substantially W-shaped.
36. Regulating system (150) according to one of propositions 22 to 35 and according to proposition 25 or 28, wherein the connecting member (5) comprises two plates (51, 52) for receiving the first and second connecting members (12, 32), the two plates (51, 52) being linked to the frame (6) by the second elastic return element (2).
37. Regulating system (150) according to one of propositions 22 to 36, wherein at least one of the first, second and third elastic return elements may comprise, at least partially:
   monocrystalline silicon of any orientation, and/or
   polycrystalline silicon, and/or
   amorphous silicon, and/or
   amorphous silicon dioxide, and/or
   doped silicon of any type and level of doping, and/or
   porous silicon, and/or
   silicon carbide, and/or
   glass, and/or
   a composite material, and/or
   technical ceramic, and/or
   quartz. and/or
   a metal, and/or
   a metal alloy, in particular an alloy made from Nb—Zr or Nb—Ti.
38. Adjustment device (200) for a regulating system (150) according to one of propositions 22 to 37 and according to proposition 23, the device (200) being a device for modifying a third stiffness k3 of a third elastic return element (3), in particular a device for modifying an active length of the third elastic return element (3), in particular a device for modifying an active length of at least one blade (31) of the third elastic return element (3), in particular a device for modifying an active length of at least one rectilinear or curved or spiral-shaped blade (31) of the third elastic return element (3).
39. Adjustment device (200) according to proposition 38, wherein it comprises a one-piece structure (900) intended to be mounted on a frame (6) of a timepiece movement (300) of a timepiece (400).
40. Adjustment device (200) according to proposition 39, wherein it comprises a connecting member (5) intended to support a first elastic return element (1) of a regulating system according to one of propositions 22 to 37 and forming part of the one-piece structure (900).
41. Adjustment device (200) according to proposition 39 or 40, wherein it comprises the hairspring (1) of a regulating system according to one of propositions 22 to 37, the hairspring (1) forming part of the one-piece structure (900).
42. Timepiece movement (300) comprising a regulating system (150) according to one of propositions 22 to 37 and/or a device (200) according to one of propositions 38 to 41.
43. Timepiece (400), in particular a wristwatch (400), comprising a regulating system (150) according to one of propositions 22 to 37 and/or a device (200) according to propositions 38 to 41 and/or a timepiece movement (300) according to proposition 42.
44. Method for adjusting an oscillator (100) of a regulating system (150) according to one of propositions 22 to 37 or a timepiece movement (300) according to proposition 42 or a timepiece (400) according to proposition 43, the method comprising a step of modifying the third stiffness k3 of the third elastic return element (3). in particular of

modifying an active length of the third elastic return element (3), in particular of modifying an active length of at least one blade (31) of the third elastic return element (3).

The appended drawings show, by way of example, two embodiments of a timepiece according to the invention.

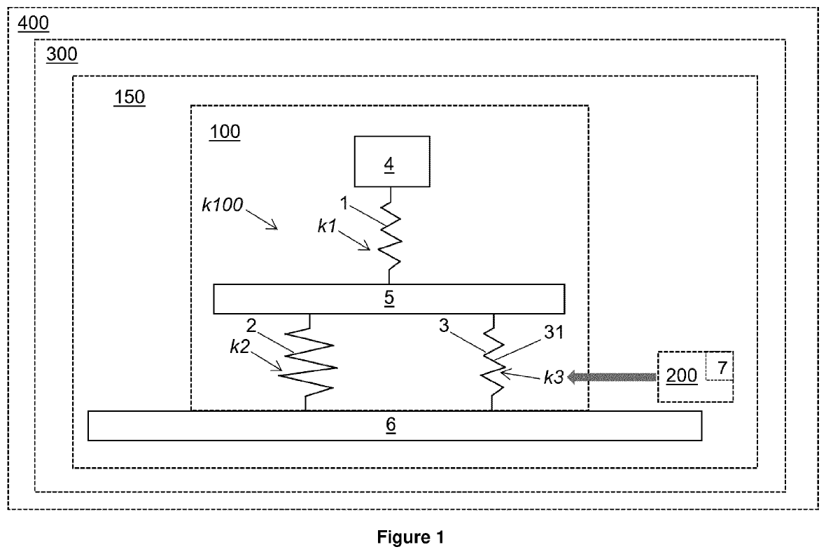

FIG. 1 is a schematic view of the principle of the general structure of a timepiece according to the invention.

FIG. 2 is a schematic view of a first variant of a first embodiment of a regulating system.

FIG. 3 is a schematic view of a second variant of the first embodiment of the regulating system.

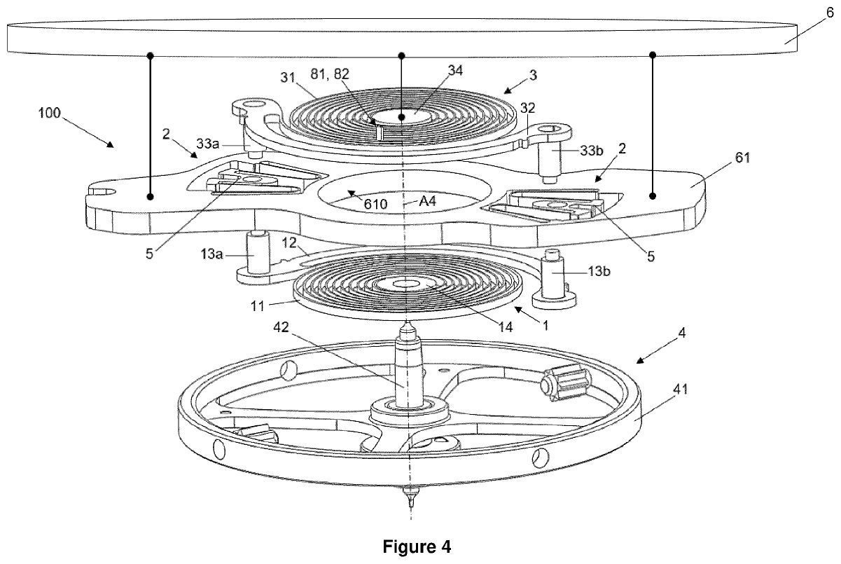

FIG. 4 is an exploded perspective view of a third variant of the first embodiment of the regulating system.

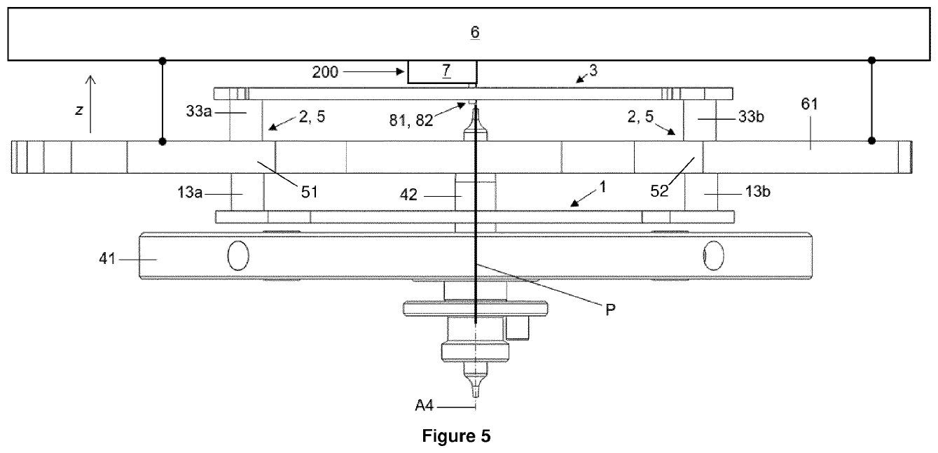

FIG. 5 is a side view of the third variant of the first embodiment of the regulating system.

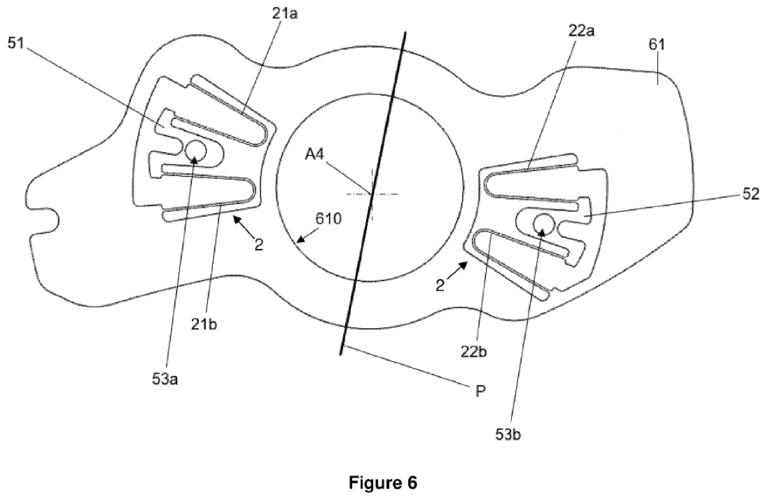

FIG. 6 is a top view of part of the third variant of the first embodiment of the regulating system.

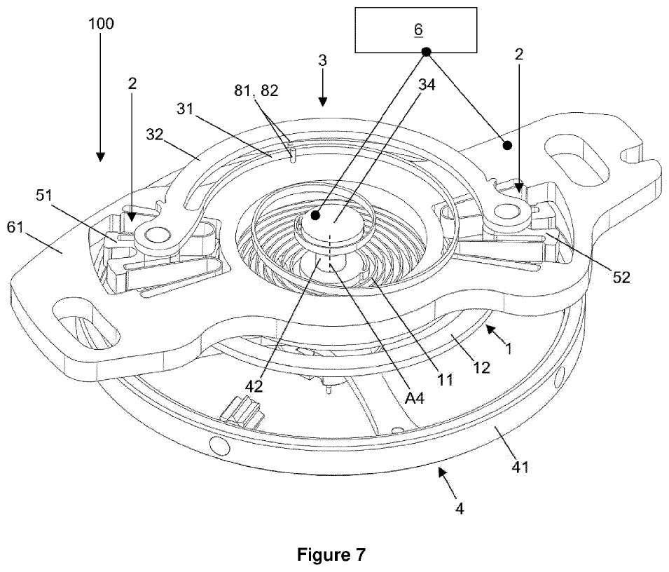

FIG. 7 is a perspective view of a fourth variant of the first embodiment of the regulating system.

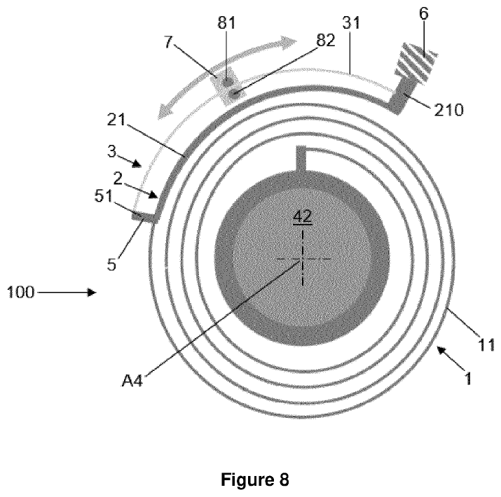

### FIG. 8 is a schematic view of a fifth variant of the first embodiment of the regulating system.

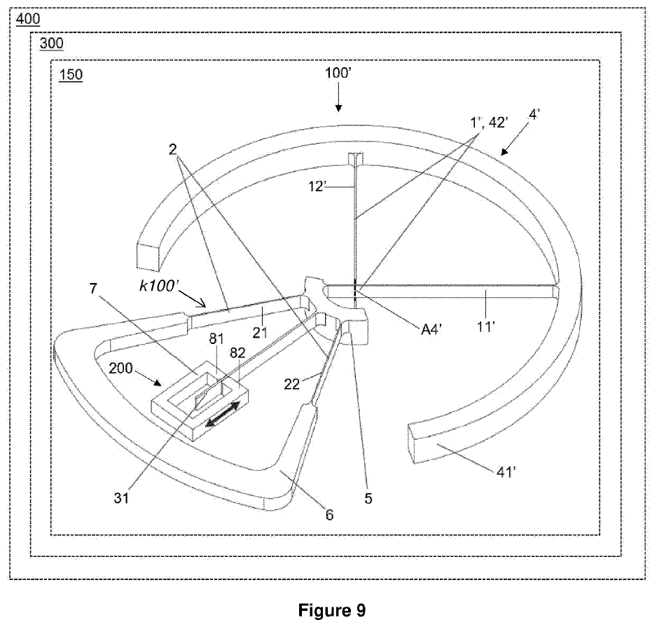

FIG. 9 is a view of a timepiece incorporating a first variant of a second embodiment of a regulating system.

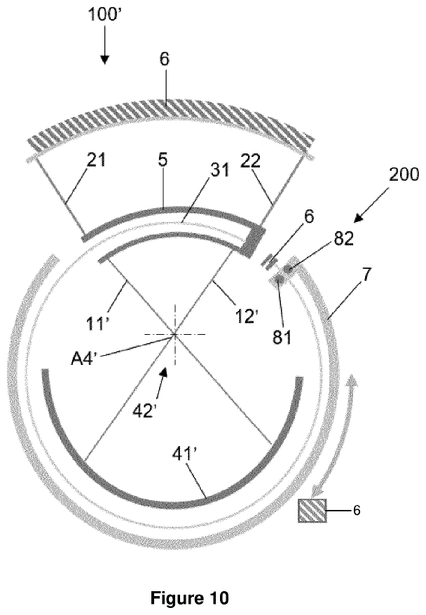

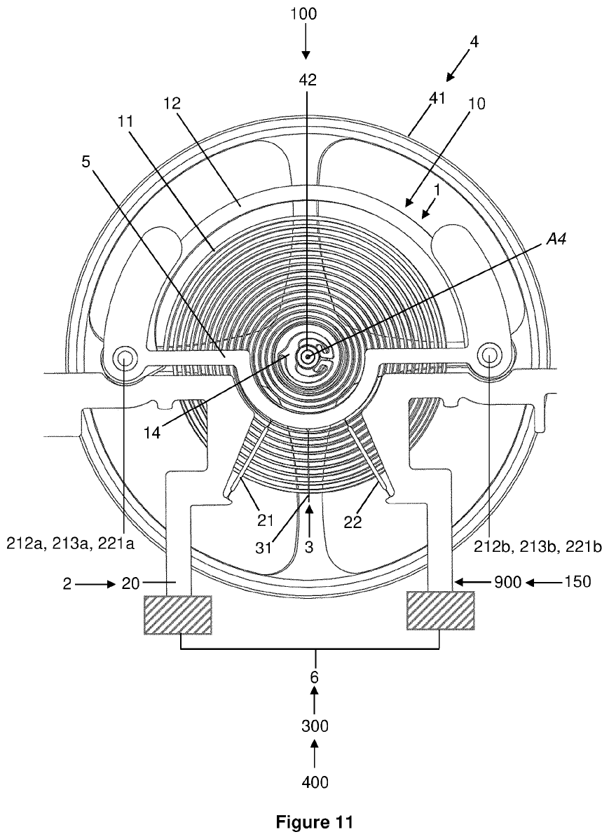

FIG. 10 is a schematic view of a second variant of the second embodiment of the regulating system.

FIG. 11 is a view specifying the structure of the first variant of the first embodiment of the regulating system.

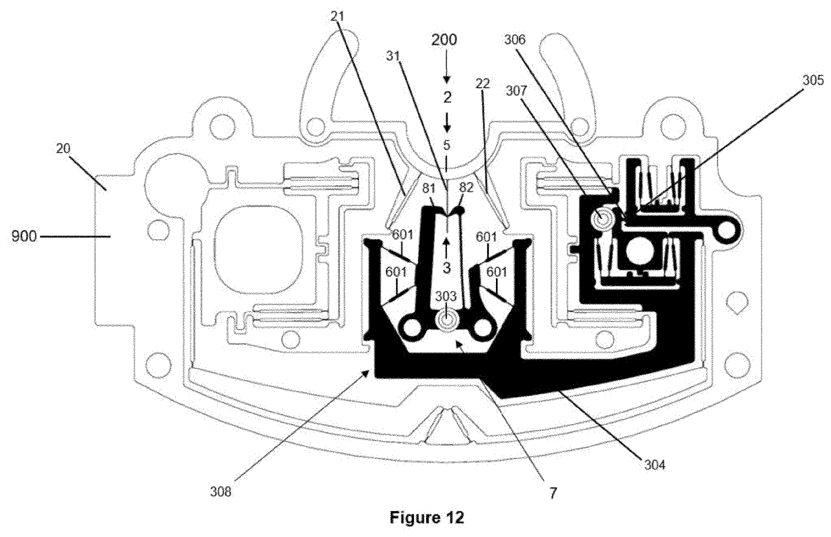

FIG. 12 is a partial detailed view of the structure of the first variant of the first embodiment of the regulating system. Irrespective of the embodiment or the variant, a timepiece 400 is described hereinafter in detail in reference to FIG. 1.

The timepiece 400 is, for example, a watch, in particular a wristwatch. The timepiece 400 comprises a timepiece movement 300 intended to be mounted in a timepiece case or casing in order to protect it from the outside environment.

The timepiece movement 300 may be a mechanical movement, in particular an automatic movement, or even a hybrid movement, i.e., a mechanical movement comprising electronic components.

The timepiece movement 300 comprises a regulating system 150.

The regulating system 150 comprises:
a frame 6,
an oscillator 100; 100′ including an inertial element 4; 4′ and an elastic

return system 1; 1′, 2, 3, and
preferably, a device 200 for modifying the stiffness of an elastic return element 3 of the elastic return system, in particular by modifying an active length of the elastic return element 3.

According to the first aspect of the invention, the regulating system 150 for a timepiece movement 300 comprises:
the inertial element 4; 4′,
the frame 6, and
the elastic return system 1; 1′, 2, 3 intended to link the inertial element 4; 4′ to the frame 6,
the elastic return system 1; 1′, 2, 3 comprising:
a first elastic return element 1; 1′ having a first stiffness k1,
a second elastic return element 2 having a second stiffness k2,
a third elastic return element 3 having a third stiffness k3, and
the device 200 for modifying the third stiffness k3, in particular by modifying an active length of the third elastic return element 3.

The first elastic return element 1; 1′ and the second elastic return element 2 are assembled in series between the inertial element 4; 4′ and the frame 6, and the third elastic return element 3 and the second elastic return element 2 are assembled in parallel between the frame 6 and the first elastic return element 1; 1′.

According to the second aspect of the invention, the regulating system 150 for a timepiece movement 300 comprises:
the frame 6,
an inertial element 4 in the form of an assembled balance 4 pivoted in relation to the frame 6 about a geometric axis A4,
the elastic return system 1, 2, 3 intended to link the assembled balance 4 to the frame 6.

The elastic return system 1, 2, 3 comprises:
a first elastic return element in the form of a first hairspring 1 having a first stiffness k1,
a second elastic return element 2 having a second stiffness k2, and
a third elastic return element 3 having a third stiffness k3.

The first elastic return element 1 and the second elastic return element 2 are assembled in series between the assembled balance 4 and the frame 6, and the third elastic return element 3 and the second elastic return element 2 are assembled in parallel between the frame 6 and the first elastic return element 1.

Two elastic return elements of a system are said to be “in series” when they follow one after another or are linked to each other by one of their respective ends, so as to connect two separate elements, which means that, when a mechanical load of a given intensity is applied to the system, in particular to one or other of the two separate elements, each of the two elastic return elements is subjected at least substantially to this given intensity of this load.

Two elastic return elements of a system are said to be “in parallel” when they directly connect two separate elements by their two respective ends, which means that, when a deformation of a given intensity is applied to the system, each of the two elastic return elements is deformed at least substantially by this intensity.

The regulating system and/or the oscillator are specifically shaped and/or arranged to allow fine adjustment of the rate of the movement by modifying the stiffness of an elastic return element forming part of said oscillator. This adjustment may be carried out, in particular, by modifying the effective or active length of at least one elastic blade of an elastic return element forming part of said oscillator, in particular by means of a lever or a framework that can be moved in relation to the frame.

The oscillator 100, which is shown schematically in FIG. 1, has the particularity of comprising:
the first elastic return element 1 of stiffness k1 linked to the inertial element 4,
the second elastic return element 2 of stiffness k2 linked in series with the first elastic return element 1, and
the third elastic return element 3 of stiffness k3 also linked in series with the first elastic return element 1 and in parallel with the second elastic return element 2, the stiffness k3 of this third elastic return element 3 being modifiable by means of the device 200 for modifying the stiffness k3 of the third elastic return element 3. Advantageously, the stiffness k3 of this third elastic return element 3 may be modified by modifying the effective or active length of at least one elastic blade 31 of said third elastic return element 3, in particular by means of a lever or framework 7. More advantageously, the stiffness k3 of this third elastic return element 3 can be modified by modifying the effective or active length of only an elastic blade 31 of said third elastic return element 3; the first and second elastic return elements 1, 2 have no device for modifying their respective stiffnesses k1, k2. This configuration offers the advantage of simplifying the use of the adjustment system and/or of the regulating system compared with another system in which effective lengths of a plurality of elastic blades may be modified.

The rate adjustment obtained using this configuration is finer when only the effective length of a single blade 31 is adjustable throughout the elastic return system comprising the three elastic return elements 1, 2, 3. This single stiffness adjustment will therefore have a smaller effect on the overall stiffness of the elastic return system comprising the three elastic return elements 1, 2, 3, which will enable finer adjustment of the system. Thus, advantageously, the adjustment device 200 acts exclusively on a single blade 31 of the third elastic return element 3.

The research undertaken by the inventors demonstrates that such an arrangement of the return elements 1, 2, 3 of the oscillator 100 allows particularly fine adjustment of the rate for carefully chosen stiffnesses k1, k2, k3. For example, for an oscillator 100 provided with a frequency of 4 Hz, and for a given stiffness k1, and when k2=20×k1 and k3=k1, a variation of ±10% in the stiffness k3 results in a rate variation in the timepiece comprising the oscillator 100 that is equal or substantially equal to ±10 secs/day.

It appears that a variation of approximately ±10% in the stiffness k3 of the third elastic return element 3 may be made possible by the use of a lever or framework that allows the effective or active length of at least one elastic blade 31 of the third elastic return element 3 to be adjusted. The lever or the framework may be operated by a watchmaker or by any autonomous device. For example, such a variation in stiffness of approximately ±10% may be caused by moving a lever or framework by an angle of a few degrees or approximately ten degrees about the axis A4.

The regulating system 150 is described hereinafter according to different embodiments and variants which involve either the use of traditional watchmaking elements such as a balance and at least one hairspring, or flexible guides and elements suitable for forming a one-piece component.

In the first embodiment (shown in FIGS. 2 to 8), the first elastic return element is in the form of a hairspring 1 that is linked to an inertial element 4.

In the second embodiment (shown in FIGS. 9 and 10), the first elastic return element is in the form of a flexible guide 1′ designed to elastically return, and also to guide, and in particular to pivot, the inertial element 4′.

Different variants of these two embodiments are described hereinafter. In these variants:
the third elastic return element may be in various forms such as a straight or curved elastic blade, or a hairspring, and
the inertial element may be limited to an oscillating mass or be in the form of a balance pivoted by a staff (commonly referred to as an “assembled balance”). In the latter case, the staff may be secured to the balance, in particular by being driven in. Alternatively, the staff may be integral with the balance. In other words, the staff and the balance may form a one-piece component.

Irrespective of the embodiment or the variant, the first elastic return element 1 may be linked respectively to the second and third elastic return elements 2, 3 by means of a connecting member 5, as shown in FIGS. 1 to 10. Advantageously, this connecting member 5 may be a rigid element helping to mechanically decouple the second and third elastic return elements 2, 3 from the first elastic return element 1 linked to the inertial element, so that any disturbances caused by the second and third elastic return elements 2, 3 (such as, for example, non-linearity of the stiffnesses k2 and k3) have less of an effect on the operation of the assembly constituted by the inertial element and the first elastic return element.

Irrespective of the embodiment or the variant, the second and third elastic return elements 2, 3 are linked to the frame 6. The frame may be a frame of the timepiece movement 300, in particular a movement blank 6, such as a plate or a bridge, in particular a balance bridge.

Irrespective of the embodiment or the variant, the third elastic return element 3 may be linked to the frame 6 by means of an adjustment element 7 of the modification device 200.

Irrespective of the embodiment or the variant (implementing a hairspring or a flexible guide as a first elastic return element), one advantageous way of producing the second elastic return element consists in using an RCC (Remote Center Compliance) pivot, constituted by at least two embedded blades, whose purpose is to guide the connecting member 5. The virtual center of intersection of the flexible blades that constitute the RCC pivot may advantageously coincide with a point through which the geometric axis A4 of the inertial element passes (for the first embodiment) or coincide with a point through which the geometric (and virtual) axis A4′ of the flexible guide 1′ and the inertial element passes (for the second embodiment). This configuration improves the stability of the oscillator 100; 100′ compared with any other arrangements of the three elastic return elements.

The inertial element 4; 4′, in particular the “assembled balance 4”, or more generally the oscillator 100; 100′ or the regulating system 150, regulates a finishing chain or finishing gear of the movement 300 by means of a watch escapement. Any known watch escapement structure and any known finishing gear structure may be used.

In a first variant (shown schematically in FIG. 2) of the first embodiment, the first elastic return element is in the form of a hairspring 1 provided with a blade 11, a first proximal end of which is linked to an oscillating mass 41 of an inertial element 4 by means of a staff 42 of geometric axis A4.

The second elastic return element 2 comprises two elastic blades 21, 22. The two blades 21, 22 are preferably straight. They are, for example, oriented radially in relation to the pivot axis A4 of the inertial element 4.

The third elastic return element 3 is in the form of a single elastic blade 31. The blade 3 is preferably straight. The blade 31 is, for example, oriented radially in relation to the pivot axis A4 of the inertial element 4.

The blades 21, 22, 31 are linked, at each of their first ends, to the hairspring 1, at an end portion 5 of the hairspring 1, which is substantially more rigid than the blade 11 and extends the blade 11 at the distal end of the hairspring 1. These blades 21, 22, 31 are also linked, at each of their second ends, to the frame 6. In particular, the second ends of the blades 21, 22 are embedded, in particular permanently embedded, in the frame 6. Also, in particular, the second end of the blade 31 is engaged or held between two pins 81, 82 secured to the adjustment element 7 consisting of a lever 7 or a framework 7 that is linked to the frame 6 while being able to be moved in translation in relation to said frame 6. The pins allow the third blade 31 to be clamped and/or held and/or supported at the point of contact with the pins. At these points of contact, the deflection of the third blade 31 is limited, or even cancelled out. The bending of the blade thus occurs between its point of connection to the end portion 5 and the points of contact with the pins. As a result, the effective or active length of the third blade which is bending can be adjusted by moving the lever 7 or the framework 7. The effect of this is to modify the stiffness k3 of the third blade 31.

During the operation of the oscillator 100, the inertial element 4 oscillates about the axis A4, which causes expansion and compression of the blade 11, and also deflection of the blades 21, 22, 31. In particular, the blades 21, 22 define a flexible guide linking the blade 11 and the connecting member 5 of the hairspring 1 to the frame 6. In particular, in this case, the blades 21, 22 define an RCC (Remote Center Compliance) pivot linking the blade 11 and the connecting member 5 of the hairspring 1 to the frame 6. The axis of the RCC pivot preferably coincides with the geometric axis A4 about which the inertial element 4 is pivoted. Modifying the effective length of the blade 31 (and therefore its stiffness k3, as previously described) makes it possible to vary the stiffness k100 of the oscillator 100 comprising such a hairspring 1 linked in series respectively with the blades 21, 22, and the blade 31.

As previously described, this is made possible by virtue of the pins 81, 82, which provide abutments and define the effective length of the blade 31 under the effect of a translational movement of the lever 7 or the framework 7.

The research undertaken by the inventors demonstrates that such an arrangement of the blades 11, 21, 22, 31 for the oscillator 100 allows particularly fine adjustment of the rate for carefully chosen stiffnesses k1, k2, k3. For example, for an oscillator 100 having an operating frequency of 4 Hz, and for a given stiffness k1, and when k2=20×k1 and k3=k1, a variation of ±10% in the stiffness k3 results in a rate variation in the timepiece comprising the oscillator 100 that is equal or substantially equal to ±10 secs/day.

In a second variant (shown schematically in FIG. 3) of the first embodiment, the blade 31 has a curved (circular or substantially circular) geometry, and its effective length may be adjusted by means of a lever 7 or a framework 7 that can be rotated. These features are, in particular, the only differences with the first variant of the first embodiment.

For example, in this second variant, the connecting member 5 has a slightly more complex configuration than that of the connecting member 5 of the first variant. In particular, the connecting member 5 according to this second variant may have elbow-shaped geometry. The connecting member 5 may have a first circular or substantially circular portion extending about the axis A 4 to secure the blades 21, 22 to the blade 11 (in an identical manner to the first variant) and a second straight portion oriented radially or substantially radially in relation to the axis A4, being designed to secure the blade 31 to the blade 11.

The other end of the blade 31 is preferably embedded in the frame 6. However, the effective or active length of this blade 31, which moves to either side of its rest position under the effect of the oscillations of the inertial element 4 about the geometric axis A4, is defined by pins 81 and 82 that are secured to a lever or framework 7 that can rotate in relation to the frame 6. As in the first variant, the pins 81 and 82 provide points of abutment against the blade 31 and thus define one end of the effective or active length of this blade 31, i.e., they define the length of the blade 31 that is effectively subjected to bending.

In a third variant (shown in FIGS. 4 to 6) of the first embodiment, the third elastic return element is in the form of a hairspring 3 provided with a blade 31 whose proximal end 34 is linked or fastened to the frame 6 (shown schematically in FIGS. 4 and 5). This hairspring 3 is linked to the hairspring 1, in particular to the blade 11 of the hairspring 1, by means of a connecting member 5, which connecting member 5 is mechanically linked to the frame 6 via a second elastic return element 2. The frame is in this case preferably a movement blank 6, such as a bridge, in particular a balance bridge.

In particular, the second elastic return element 2 and the connecting member 5 are integral with an intermediate member 61 that is fixed or attached to the rest of the frame 6. The intermediate member 61 therefore forms part of the frame 6. More generally, the second elastic return element 2 and the connecting member 5 are included within the same intermediate member 61 fixed to the rest of the frame 6.

This intermediate member 61, which is shown specifically in FIG. 6, is in the form of a generally elongate panel. This intermediate member 61 is advantageously provided with two pairs of elastic blades 21a, 21b and 22a, 22b forming the second elastic return element 2.

In particular, these two pairs of blades are arranged symmetrically with respect to a plane P passing through the geometric axis A 4 of the staff 42 that is linked to the balance 41, the staff 42 passing through a central opening 610 of the member 61.

The pair of blades 21a, 21b elastically links a first portion or plate 51 to the intermediate member 61. The pair of blades 22a, 22b elastically links a second portion or plate 52 to the intermediate member 61. The portions or plates 51 and 52 together constitute the connecting member 5. The plates 51, 52 are therefore respectively secured to the pairs of blades 21a, 21b and 22a, 22b.

Each of these plates 51, 52 is intended to be fastened respectively to a first respective end 13a, 33a and to a second respective end 13b, 33b of the hairsprings 1 and 3. The hairsprings 1, 3 are thus linked to the plates 51, 52 constituting the connecting member 5. These plates are themselves linked to the frame 6 by the elastic blades 21a, 21b and 22a, 22b.

The member 61 fastened to the rest of the bridge 6 can thus constitute a support for the hairsprings 1 and 3.

In particular, the first ends 13a, 13b and second ends 33a, 33b are each in the form of studs or pins intended to be fitted, in particular driven, into openings 53a, 53b respectively formed at each of the plates 51, 52. Alternatively, the two plates could comprise studs and the connecting members of the hairsprings could comprise openings for receiving or driving these studs into.

Each of the plates 51, 52 is formed in the continuation of the blades 21a, 21b and 22a, 22b which are each, in this case, U-shaped or substantially U-shaped. Alternatively, the elastic blades 21a, 21b and 22a, 22b may each be V-shaped or substantially V-shaped or W-shaped or substantially W-shaped, for example. Alternatively, the elastic blades 21a, 21b and 22a, 22b may each be shaped in such a way as to achieve the required stiffness value, for example.

In particular, the structures 21a, 21b, 51 and 22a, 22b, 52 constitute unitary or single-piece elements. More generally, these structures are included within the intermediate member 61, the latter forming a one-piece component. The unitary component may incorporate the two plates 51, 52.

The pairs of studs 13a, 13b and 33a, 33b are respectively secured to a connecting member 12, 32 formed respectively in the continuation of the blades 11, 31 of the hairsprings 1, 3, at their distal end. In particular, these two pairs of studs are arranged symmetrically with respect to the abovementioned plane P, meaning that they are each able to cooperate with the pairs of elastic blades 21a, 21b and 22a, 22b by means of the plates 51, 52 that form the connecting member 5.

The first connecting member 12 is arranged at a first distal end of the first blade 11 and links the first hairspring 1 to the second elastic return element 2, in particular by means of the connecting member 5.

The second connecting member 32 is arranged at a second distal end of the third blade 31 and links the second hairspring 3 to the second elastic return element 2, in particular by means of the connecting member 5.

Each of these pairs of elastic blades 21a, 21b and 22a, 22b defines a flexible guide for the hairsprings 1 and 3, in particular an RCC pivot (the virtual center of which coincides with the axis A4), while linking the hairsprings 1 and 3 by means of the portions 51, 52.

In the construction example shown in FIGS. 4 and 5, the intermediate member 61 is arranged at the interface of the hairsprings 1 and 3. In other words, the intermediate member is arranged between the hairsprings 1 and 3 according to the axis A4 or according to a vertical direction z represented schematically by an arrow in FIG. 5.

The modification device 200 may, for example, be arranged between the hairspring 3 and the frame 6, in particular the balance bridge 6 (according to the vertical direction z). As described in the preceding variants and as can be seen, more particularly, in FIG. 5, pins 81, 82 are secured to a lever 7 or framework 7, which is linked to the frame 6 while being able to be rotated in relation to said frame 6.

Advantageously, the blades 11 and 31 of the hairsprings 1, 3 may be similar or substantially similar, or even identical. Therefore, advantageously, k3=k1. For example, for an oscillator 100 provided with a frequency of 4 Hz, and for a given stiffness k1 that is equal to k3, and when k2=20×k1, a variation of ±10% in the stiffness k3 results in a rate variation in the timepiece comprising the oscillator 100 that is equal or substantially equal to ±10 secs/day.

Such a variant has the advantage of using traditional watchmaking elements (for example, the hairsprings 1, 3, the assembled balance 4) while facilitating assembly by means of the specific configuration of the intermediate member 61, which has the advantage of combining the functions of the second elastic return element 2 and the connecting member 5.

Moreover, the balance 41, the staff 42 and the hairspring 1 (fastened to the staff 42 by means of a collet 14, for example) have the advantage that they can be assembled directly on a frame 6 if allowing adjustment by means of a modification device 200 is not desirable. Therefore, this assembly 41, 42, 1 may constitute a standardized assembly that can be incorporated both into a conventional movement and into a movement 300 provided with a modification device 200.

The collet 14 is preferably arranged at a first proximal end of the first blade 11 and fastened to the staff 42 secured to the balance 41.

Advantageously, the collet 14, the first blade 11 and the first connecting member 12 form a one-piece component. Similarly, advantageously, the second proximal end 34, the second blade 31 and the second connecting member 32 may form a one-piece component.

A fourth variant (shown in FIG. 7) of the first embodiment essentially differs from the third variant in that the third blade 31 is far more rigid.

Compared with the third variant, the cross section of the blade 31 is greater and/or the length of the blade 31 is shorter. For example, the stiffness of the second elastic return element 2 and the stiffness of the third elastic return element 3 are equal or substantially equal.

Indeed, the research undertaken by the inventors also shows that, for an oscillator 100 provided, for example, with a frequency of 4 Hz, and for a given stiffness k1, and for a second stiffness k2 and a third stiffness k3 that are similar or of the same order, substantially greater than the stiffness k1, of approximately 125×k1, a variation of ±10% in the stiffness k3 results in a rate variation in the timepiece comprising the oscillator 100 that is equal or substantially equal to ±15 secs/day.

In a fifth variant (shown schematically in FIG. 8) of the first embodiment, it is proposed that the second elastic return element 2 and the connecting member 5 are formed in the continuation of the blade 11 of the hairspring 1. Therefore, in this case, the second elastic return element 2 is in the form of a curved elastic blade 21 more rigid than the blade 11. The connecting

member 5 is in the form of an elbow 51 (oriented radially or substantially radially in relation to the axis A4), which is formed at the distal end of the blade 11. This links the blade 11 to a curved elastic blade 31 forming the third elastic return element, and also links the latter to the curved elastic blade 21. The distal ends of the blades 21 and 31 are linked to the frame 6 by means of an elbow 210 formed at the distal end of the blade 21, for example by a fixed connection.

The effective length of the curved elastic blade 31 is again adjusted by pins 81, 82 of a lever 7 or framework that can be rotated with respect to the frame 6.

According to the second embodiment, the first elastic return element 1′ is in the form of a flexible guide 1′ designed to elastically return, and also to guide, and in particular to pivot, an inertial element 4′ about an axis A4′. To this end, the first elastic return element 1′ may comprise two blades 11′ and 12′ that intersect in such a way as to form, for example, a Wittrick pivot. In particular, these blades 11′ and 12′ are arranged in two distinct parallel planes. These blades 11′, 12′ are linked, at each of their first ends, to a connecting member 5. These blades 11′, 12′ are also linked, at each of their second ends, to an oscillating mass 41′. Therefore, the inertial element 4′ may comprise the oscillating mass 41′, and also the blades 11′ and 12′ forming the first elastic return element 1′ and a guide element 42′.

According to a first variant of the second embodiment (shown in FIG. 9 and the principle of which is comparable to the first variant of the first embodiment), the second elastic return element 2 comprises two straight elastic blades 21, 22 constituting an RCC pivot, and the third elastic return element 3 is in the form of a single straight elastic blade 31, each of these blades 21, 22, 31 extending radially or substantially radially in relation to the axis A4′.

The blades 11′, 12′ and 21, 22 and 31 are linked to each other, at each of their first ends, by means of a connecting member 5. The blades 21, 22, 31 are also linked, at each of their second ends, to the frame 6. In

particular, the second ends of the blades 21, 22 are permanently embedded in the frame 6, and the second end of the blade 31 is engaged between two projections 81, 82 secured to a framework 7 of a modification device 200, which is linked to the frame 6 while being able to be moved in translation in relation to said frame 6.

During the operation of the oscillator 100′, the mass 41′ oscillates about the axis A4′, which causes bending of the blades 11′ and 12′, and also deflection of the blades 21, 22, 31. In particular, the blades 21, 22 define a flexible guide linking the blades 11′, 12′ and the connecting member 5 to the frame 6. In particular, the blades 21, 22 define an RCC pivot linking the blades 11′, 12′ and the connecting member 5 to the frame 6. The axis of the RCC pivot preferably coincides with the geometric (and virtual) axis A4′ about which the inertial element 4′ is pivoted. Modifying the effective length of the blade 31 makes it possible to vary the stiffness k100′ of the oscillator 100′ comprising such a first elastic return element 1′ linked in series respectively with the blades 21, 22, and the blade 31.

The research undertaken by the inventors has demonstrated that such an arrangement of blades 11′, 12′, 21, 22, 31 for an oscillator 100′ allows particularly fine adjustment of the rate for carefully chosen stiffnesses k1′, k2, k3. For example, for an oscillator 100′ provided with a frequency of 10 Hz, and for a given stiffness k1′, and when k2=20×k1′ and k3=k1′, a variation of ±10% in the stiffness k′ results in a rate variation in the timepiece comprising the oscillator 100 that is equal or substantially equal to ±10 secs/day.

A second variant of the second embodiment (shown in FIG. 10) is substantially the same as the first variant, except that the blade 31 has curved geometry, and its effective or active length can be adjusted by means of a lever 7 that can be rotated.

To this end, the connecting member 5 has a slightly more complex configuration than that of the connecting member 5 of the first variant. In particular, the connecting member 5 according to this second variant has elbow-shaped geometry. Two first circular or substantially circular portions extend about the axis A4′ to secure the blades 21, 22 to the blades 11′ and 12′, and a second straight portion, oriented radially or substantially radially in relation to the axis A4′, is designed to secure the blade 31 to the blades 11′, 12′.

The other end of the blade 31 is embedded in the frame 6. However, the effective length of this blade 31, which moves to either side of its rest position under the effect of the oscillations of the inertial element 4′ about the virtual axis A4′, is defined by the pins 81 and 82 that are secured to the rotary lever 7 mechanically linked to the frame 6.

One example of the structure of the first variant of the first embodiment of the regulating system is described hereinafter with reference to FIGS. 11 and 12.

The oscillator 100 comprises an oscillating mass 41 of an inertial element 4, notably a balance, and a first elastic return element 1, notably a hairspring. The oscillator 100 further comprises a second elastic return element forming part of a support 2 of the first elastic return element 1.

The hairspring 1 is provided with a blade 11:
of which a first proximal end 14 is connected to the oscillating mass 41 by means of a staff 42 with geometric axis A4, and
of which a second distal end comprises a first connecting member 12 intended to be fixed to a second connecting member 5 of the support 2, notably via posts or pins 213a, 213b which are intended to be inserted respectively into openings 212a, 212b and 221a, 221b formed respectively on the first and second connecting members, particularly at each of the ends thereof.

The second connecting member 5 is fixed to a rigid framework 20 via elastic blades 21, 22, each one provided with flexible portions at their respective ends. Thus, the second elastic return element takes the form of the second connecting member 5 articulated to the framework 20 via the elastic blades 21, 22.

A third elastic return element 3 itself takes the form of a single, in this instance rectilinear, elastic blade 31 which is secured to the second connecting member 5 and which, for example, is arranged between the elastic blades 21, 22 at the exterior periphery of the second connecting member 5.

In the embodiment described, the elements 20, 21, 22, 5 of the support 2 and the blade 31 of the third elastic return element 3 form a one-piece structure 900 of the regulating system 150, which is secured to the frame 6 of the timepiece 400, particularly of the movement 300.

In the embodiment described, a stiffness-selection device 308 for selecting the stiffness of the elastic return system 10 makes it possible to select a stiffness from among 3 predetermined stiffnesses ksr 1, ksr 2, ksr 3,
the stiffness ksr1 resulting in a nominal frequency f1 of the first oscillator 100,
the stiffness ksr2 being greater than the stiffness ksr1 and resulting in a frequency f2 higher than the frequency f1, and
the stiffness ksr3 being less than the stiffness ksr1 and resulting in a frequency f3 lower than the frequency f1.

What is meant here by “predetermined stiffness” is a stiffness determined in advance and centered on a value ksr1, ksr2 or ksr3. Naturally, these predetermined stiffnesses ksr1, ksr2, ksr3 may each vary within a given range, the amplitude of which is dependent on the tolerances of the system. As a preference, the stiffness ksr1 is capable of varying over a range that is more restricted, or even much more restricted, than those associated with the stiffnesses ksr2, ksr3, so as to result in a nominal frequency f1 in the first oscillator.

Thus, a stiffness ksr 2 of the elastic return system 10 makes it possible to correct for any loss there may be in a display device of the timepiece or makes it possible to correct for any loss in the mobile that drives any potential display device of the timepiece, and a stiffness ksr3 of the elastic return system 10 makes it possible to correct for any gain there may be in a display device of the timepiece or makes it possible to correct for any gain in the mobile that drives any potential display device of the timepiece.

In the embodiment described, the stiffness-selection device 308 for selecting the stiffness of the elastic return system 10 acts specifically on the stiffness of the third elastic return element 3, more particularly on the stiffness of the elastic blade 31. Thus, the stiffness-selection device 308 makes it possible to select a determined stiffness of the third elastic return element 3 from among 3 predetermined stiffnesses k31, k32, k33, the stiffnesses ksr1, ksr2, ksr3 of the elastic return system 10 being correlated respectively with the stiffnesses k31, k32, k33. Thus, a stiffness k31 of the elastic blade 31 makes it possible to define a nominal frequency f1 of the first oscillator 100, a stiffness k32 of the elastic blade 31 makes it possible to correct for any loss there may be in a display device of the timepiece or any loss in the mobile that drives any potential display device of the timepiece, and a stiffness k33 of the elastic blade 31 makes it possible to correct for any gain there may be in the display device of the timepiece or any gain in the mobile that drives any potential display device of the timepiece, as will be described hereinafter.

It would appear that such an arrangement of elastic return elements 1, 2, 3, with carefully chosen respective stiffnesses ksr1, ksr2, ksr3, allows particularly fine adjustment of the rate. For example, a variation of ±10% in the stiffness ksr3 results in a rate variation in the timepiece comprising the first oscillator 100 that is equal or substantially equal to ±10 secs/day.

By way of illustration, FIG. 12 indicates the selection device 308 drawn in black. This device here forms part of the one-piece structure 900 intended to be attached to the frame 6 of the movement 300, particularly to a blank.

Thus, more generally, the selection device 308 comprises a regulating element 7 or at least a pair of clamps 81, 82 which are intended to act on the active length of the elastic blade 31, as well as a selection beak 306 collaborating with a toothed structure 305 which are intended for positioning the pair of clamps 81, 82 in one of three stable positions predefined by the teeth of the structure 305.

This selection device 308 can be actuated in order to position the pair of clamps 81, 82 in three stable positions by moving the selection beak 306 past the toothed structure 305.

Overall, the stiffness adjustment or modification device 200 may comprise a one-piece structure 900 of which the clamps 81 and 82 form part, the clamps being able to be moved (along the third blade 3) relative to a base 20 of the one-piece structure 900, this base 20 being fixed to the frame 6.

More precisely, the clamps 81, 82 are connected to a framework 304 via flexible blades 601 and the framework 304 is connected to the base 20 via flexible blades. As a result of this structure, the clamps 81, 82 (and more generally the assembly comprising the framework 304) can be moved relative to the frame.

The selection device 308 comprises the clamps 81, 82, the framework 304 and the base 20. The toothed structure 305 may be produced on one of either the framework 304 or the base 20, and the selection beak may be produced on the other of either the framework 304 or the base 20.

The exemplary embodiment of FIGS. 11 and 12 is notable for the following features:
the regulating element 7 comprises two projections or clamps 81, 82 which are mounted on the frame 6 via elastic blades 601 and are returned against the third elastic blade 3 by virtue of a preloaded element or post 303; and/or
the clamps 81, 82 are incorporated into a one-piece structure 900 of which a base 20 is intended to be supported on the frame 6; and/or
the blades 21, 22 of the second elastic return element are also formed within this one-piece structure 900 and are connected to the connecting member 5 (of the first elastic return element) and to a base 20 mounted on the frame 6; and/or
one end of the third elastic blade may be free; and/or
the first elastic return element 1 (which may take the form of a hairspring) may be formed within the one-piece structure 900; and/or
the support 5 or the connecting member 5 (supporting the first elastic return element 1, particularly supporting the hairspring) is formed as one piece with the one-piece structure 900 or forms part of the one-piece structure; and/or
the clamps 81, 82 act to immobilize the third elastic blade in a transverse direction of the third blade (and in the plane of FIG. 12); and/or
the clamps 81, 82 act without preloading or deforming the third blade.

These features, which are illustrated in the first variant of the first embodiment of the regulating system in FIGS. 11 and 12, may be employed irrespective of the embodiment or variant of the regulating system.

More generally, the selection device 308 may also be intended for positioning the pair of clamps 81, 82 in n stable positions by moving the selection beak 306 past the toothed structure 305. Advantageously, n may be equal to 3, but may also be different, notably may be equal to 2 or be equal to 4 or to 5. Alternatively, the selection device may be a continuous-adjustment system. In that case, it is not a discrete-adjustment system comprising n predefined positions of adjustment, but an adjustment system that can be actuated for example by means of an eccentric able to oscillate through a determined range without any notches or discrete positions.

Irrespective of the embodiment or the variant, the oscillator 100, 100′ may be a one-piece component or constituted by an assembly of elements.

The hairsprings 1, 3 described in this document preferably comprise a single blade. Naturally, it is possible to implement at least one hairspring comprising several blades, such as two blades, in one or more planes.

Irrespective of the embodiment or the variant, the oscillator 100; 100′ may comprise one or more other elastic return elements in addition to the first, second and third elastic return elements described in the document. For example, the oscillator 100; 100′ could comprise at least one fourth elastic return element for thermocompensation purposes or in order to fine-tune the correction of the rate. This could, for example, be arranged in parallel with the second and third elastic return elements.

Irrespective of the embodiment or the variant, the elastic return elements may comprise, at least partially, monocrystalline silicon of any orientation, polycrystalline silicon, amorphous silicon, amorphous silicon dioxide, doped silicon of any type and level of doping, or even porous silicon. They may also comprise silicon carbide, glass, ceramic, a composite material, or quartz. Alternatively, the elastic return elements may be constructed from metal or a metal alloy, in particular a paramagnetic metal alloy such as an alloy made from Nb—Zr or Nb—Ti.

This document describes solutions using pivoted inertial elements. Naturally, the concept of the invention can also be applied to an inertial element designed, for example, to be moved in translation.

In this document, the oscillation frequency of the inertial element may be between 3 Hz and 8 Hz, typically being 4 Hz. This frequency can of course be chosen depending on the specific requirements of the timepiece, and this frequency may also be equal to or greater than 8 Hz, for example being 10 Hz or between 10 Hz and 100 Hz, or even equal to or greater than 100 Hz.

Advantageously, irrespective of the embodiment or the variant, the stiffnesses k1, k2 and k3 are such that:
k2+k3>k1, or even k2+k3>>k1, for example k2+k3>10×k1, and/or
the second stiffness k2 is substantially greater than the first stiffness k1, in particular the second stiffness k2 is substantially greater than the first stiffness k1 and substantially greater than the third stiffness k3.

In particular, irrespective of the embodiment or the variant, the stiffnesses k1, k2 and k3 may be such that:
the first stiffness k1 and the third stiffness k3 are similar or of the same order, in particular k3=α×k1 in which 0.5≤α≤2, and
the second stiffness k2 is substantially greater than the first stiffness k1 and the third stiffness k3, in particular k2=β×k1 and/or k2=β×k3 in which 10≤β≤80, preferably β=20 or β~20.

Alternatively, irrespective of the embodiment or the variant, the stiffnesses

k1, k2 and k3 may be such that:
the second stiffness k2 and the third stiffness k3 are similar or of the same order, in particular k3=γ×k2 in which 0.5≤γ≤2, and
the second stiffness k2 and the third stiffness k3 are substantially greater than the first stiffness k1, in particular k2=δ×k1 and/or k3=δ×k1 in which 100≤δ≤200, preferably δ=125 or δ~125.

In a particular variant, the second elastic return element 2 is a curved blade 21. Advantageously, this curved blade may be formed in the continuation of a blade 11 of a hairspring 1 forming the first elastic return element 1.

In the different embodiments and variants that are described, the first, second and third elastic return elements are linked to each other by a connecting member 5. This connecting member 5 may
form part of the first elastic return element 1; 1′, or
be formed in the continuation of a blade 11 of a hairspring 1 forming the

first elastic return element 1, or
be formed in the continuation of blades 11′, 12′ of a flexible guide 1′ forming the first elastic return element 1′.

Irrespective of the embodiment or the variant, the inertial element 4; 4′ and the first, second and third elastic return elements may be made in a single piece or may form a one-piece component.

The invention also relates to an adjustment device 200 per se. The device can be used to adjust a regulating system 150; 150′ as described previously or an oscillator 100; 100′ as described previously. The adjustment device 200 may in particular be a device for modifying the stiffness k3 of a third elastic return element 3. This modification in stiffness may in particular be achieved by modifying an active or effective length of the third elastic return element 3, in particular by modifying an active or effective length of at least one blade 31 of the third elastic return element 3.

In the solutions described above, the adjustment device is a device 200 for modifying the stiffness of an elastic return element that can be used, more particularly, to modify the active or effective length of the elastic return element.

Advantageously, irrespective of the embodiment or the variant, the lever or the framework 7 may be an element that can be moved in relation to the frame and provides an abutment or a support for the third elastic return element. In particular, the abutment or support may be provided by surfaces, in particular cylindrical surfaces, of pins 81, 82 arranged to bear against the third elastic return element, and in particular against an elastic blade of the third elastic return element.

The invention also relates to a method for adjusting the oscillator 100; 100′ of the regulating system 150; 150′ described above or the timepiece movement 300 described above or the timepiece 400 described above.

The method comprises a step of modifying the third stiffness k3 of the third elastic return element 3.

This modification in the third stiffness k3 of the third elastic return element 3 may be a modification of an active length of the third elastic return element 3, in particular a modification of an active length of at least one blade 31 of the third elastic return element 3. This modification is preferably carried out using an adjustment device as described above. Such an adjustment device makes it possible, in particular, to limit, or even cancel out, the deformation of the third elastic return element 3 at a point of the third elastic return element 3, this point being movable along the third elastic return element 3.

The term “one-piece structure” is understood to mean a structure made of just one part obtained for example:
by machining from a mass of material, or
by crystal growth, or
by electroforming, or
by sintering.

This excludes a structure consisting of several elements assembled with respect to one another in a removable manner, especially with the aid of clipping or tools.

The solutions described in this document allow fine adjustment of the rate of the movement by modifying the stiffness of a given elastic return element forming part of an oscillator, in particular by modifying the effective length of at least one elastic blade of an elastic return element forming part of said oscillator, in particular by means of a lever or framework that is movable and provides an abutment for an elastic blade. The proposed solution can also be implemented in order to adjust the rate while the oscillator is in operation.

In the described solutions, the oscillator has the particularity of comprising a first elastic return element linked to an inertial element, a second elastic return element linked in series with the first elastic return element, and a third elastic return element also linked in series with the first elastic return element, in parallel with the second elastic return element 2, the stiffness of this third elastic return element being modifiable by means of an additional device for modifying the stiffness of the third elastic return element. Advantageously, the stiffness of this third elastic return element may be modified by adjusting the effective length of at least one elastic blade of said third elastic return element, in particular by means of an additional device for modifying the effective length of the third elastic return element that may be in the form of a movable lever or framework. This movable lever or framework advantageously comprises pins or projections that clamp and/or hold and/or support the third blade 31 at the point of contact with the pins or projections. At these points of contact, the

deflection of the third blade 31 is limited, or even cancelled out. Advantageously, this lever or framework comprises a pair of two pins or two projections. Naturally, this lever or framework may comprise more than two pins or two projections.

1. A regulating system (150; 150′) for a timepiece movement (300) comprising:
an inertial element
a frame, and
an elastic return system adapted to link the inertial element to the frame so that the inertial element and the elastic return system form an oscillator,
the elastic return system comprising:
a first elastic return element having a first stiffness k1,
a second elastic return element having a second stiffness k2,
a third elastic return element having a third stiffness k3, and
a device for modifying the third stiffness k3, the first elastic return element and the second elastic return element being assembled in series between the inertial element and the frame, and
the third elastic return element and the second elastic return element being assembled in parallel between the frame and the first elastic return element.

2. The regulating system as claimed in claim 1, wherein:
k2+k3>k1, and/or
the second stiffness k2 is substantially greater than the first stiffness k1.

3. The regulating system as claimed in claim 1, wherein:
the first stiffness k1 and the third stiffness k3 are of the same order, and
the second stiffness k2 is substantially greater than the first stiffness k1 and the third stiffness k3.

4. The regulating system as claimed in claim 1, wherein:
the second stiffness k2 and the third stiffness k3 are of the same order, and
the second stiffness k2 and the third stiffness k3 are substantially greater than the first stiffness k1.

5. The regulating system as claimed in claim 1, wherein the inertial element and the elastic return system are configured and/or arranged so that an oscillation frequency of the oscillator is equal to or greater than 8 Hz.

6. The regulating system as claimed in claim 1, wherein the first elastic return element is a hairspring comprising at least one blade linked to the inertial element, the inertial element being pivoted in relation to the frame about a geometric axis.

7. The regulating system as claimed in claim 1, wherein the first elastic return element is a flexible guide comprising two blades configured and/or arranged to elastically return and guide the inertial element about a geometric axis.

8. The regulating system as claimed in claim 1, wherein the second elastic return element comprises flexible blades embedded in the frame and defining an RCC pivot for the first elastic return element, in which a virtual center of intersection of the flexible blades coincides with a point through which a geometric axis passes, the inertial element being pivoted about the geometrical axis.

9. The regulating system as claimed in claim 1, wherein the third elastic return element comprises a straight or curved elastic blade.

10. The regulating system as claimed in claim 1, wherein the first, second and third elastic return elements are linked to each other by a connecting member.

11. The regulating system as claimed in claim 1, wherein the second elastic return element is a curved blade formed in a continuation of a blade of a hairspring forming the first elastic return element.

12. The regulating system as claimed in claim 1, wherein the inertial element and the first, second and third elastic return elements are made in a single piece or form a one-piece component.

13. The regulating system as claimed in claim 1, wherein at least one of the first, second and third elastic return elements comprise, at least partially:
monocrystalline silicon, and/or
polycrystalline silicon, and/or
amorphous silicon, and/or
amorphous silicon dioxide, and/or
doped silicon, and/or
porous silicon, and/or
silicon carbide, and/or
glass, and/or
a composite material, and/or
technical ceramic, and/or
quartz.

14. An adjustment device for a regulating system for a timepiece movement,
the regulating system comprising:
an inertial element,
a frame, and
an elastic return system adapted to link the inertial element to the frame so that the inertial element and the elastic return system form an oscillator,
the elastic return system comprising:
a first elastic return element having a first stiffness k1,
a second elastic return element having a second stiffness k2,
a third elastic return element (3) having a third stiffness k3, and
a device for modifying the third stiffness k3,
the first elastic return element and the second elastic return element being assembled in series between the inertial element and the frame, and
the third elastic return element and the second elastic return element being assembled in parallel between the frame and the first elastic return element,
wherein the device is configured for modifying the third stiffness k3 of the third elastic return element.

15. The adjustment device as claimed in claim 14, wherein the adjustment device comprises a one-piece structure adapted to be mounted on a frame of the timepiece movement.

16. The adjustment device as claimed in claim 15, wherein the adjustment device comprises a connecting member adapted to support the first elastic return element of the regulating system and forming part of the one-piece structure.

17. The adjustment device as claimed in claim 15, wherein the adjustment device comprises:
the first elastic return element, and
the second elastic return element, and
the third elastic return element,
of the regulating system,
the first elastic return element, the second elastic return element, and the third elastic return element forming part of the one-piece structure.

18. The adjustment device as claimed in claim 14, wherein the adjustment device comprises a pair of clamps, the pair of clamps being:
able to be moved relative to the frame, and/or
able to clamp a blade, and/or
able to move relative to the blade.

19. A timepiece movement comprising the regulating system as claimed in claim 1.

20. A timepiece comprising the regulating system as claimed in claim 1.

21. A method for adjusting the oscillator of the regulating system as claimed in claim 1,
wherein the method comprises:
modifying the third stiffness k3 of the third elastic return element.
